(19) United States
(12) Patent Application Publication
(10) Pub. No.: US 2017/0138400 A1
(43) Pub. Date: May 18, 2017

(54) BAINITE HARDENED STACK BEARING

(71) Applicant: Schaeffler Technologies AG & Co. KG, Herzogenaurach (DE)

(72) Inventor: Shawn PIERCE, Fort Mill, SC (US)

(73) Assignee: SCHAEFFLER TECHNOLOGIES AG & CO. KG, Herzogenaurach (DE)

(21) Appl. No.: 14/939,419

(22) Filed: Nov. 12, 2015

(51) Int. Cl. F16C 33/62; C21D 9/40; F16C 19/54

(52) U.S. Cl. CPC F16C 33/62; F16C 19/54; C21D 9/40; F16C 2204/66; F16C 2204/70; C21D 2211/002

(57) ABSTRACT

A stack bearing ring assembly including a plurality of rolling bearing assemblies stacked adjacent to each other is disclosed. Each of the plurality of rolling bearing assemblies includes at least one bearing ring comprised of 100 Cr6 bainitic steel.

### FIELD OF INVENTION

The present invention relates to a bearing assembly, and is more particularly related to a hardened bearing ring for a bearing assembly.

### BACKGROUND

Bearing assemblies are used in a variety of applications, including large-scale drilling applications. Drilling applications require support bearings, typically in the form of a stack bearing assembly. Stack bearing assemblies are comprised of a plurality of individual bearing assemblies, which are stacked adjacent to each other to consecutively distribute the support loads among the individual bearings.

During drilling, pressurized medium is provided to a well to flush debris from the well. As the debris exits the well, the debris travels through the rolling surfaces of the stack bearing assembly which damages the bearing components. The debris lowers the life cycle of the bearing and requires the bearing rings to be replaced more often than typical bearing applications. Replacement of these bearing rings is expensive and time consuming. The debris can also cause the bearing to be less efficient or cause the bearing rings to fracture resulting in failure of the bearing assembly. Existing bearing rings for bearings used in drilling applications are formed from 100 Cr6 martensitic steel or include case carburized alloy grade steel. These solutions fail to provide sufficient toughness and impact strength to withstand the damage caused by the debris traveling through the bearing assembly.

### SUMMARY

The present application discloses an improved bearing ring capable of withstanding the wear caused by debris in a drilling rig bearing assembly. The bearing assembly includes a bearing ring formed from 100 Cr6 bainitic steel. Bainitic steel provides increased resistance to wear from the debris traveling through the bearing assembly, and provides compressive residual surface stress for the bearing ring for increased resistance to fracture and cracking.

### BRIEF DESCRIPTION OF THE DRAWINGS

The foregoing Summary and the following detailed description will be better understood when read in conjunction with the appended drawings, which illustrate a preferred embodiment of the invention. In the drawings:

FIG. 1 is a graph showing the life factor for a bearing ring formed from 100 Cr6 martensitic steel and a bearing ring formed from 100 Cr6 bainitic steel.

FIG. 2 is a cross-sectional view of a stack bearing assembly.

FIG. 3 is a perspective view of the stack bearing assembly of FIG. 2.

FIG. 4 is a graph showing heat treatment temperature profiles for martensitic bearing steel and bainitic bearing steel.

FIG. 5A is a schematic graph illustrating the formation process for producing through hardened martensitic bearing steel.

FIG. 5B is a schematic graph illustrating the formation process for producing through hardened bainitic bearing steel.

FIG. 5C is a schematic graph illustrating the formation process for producing case carburized bearing steel.

### DETAILED DESCRIPTION OF THE PREFERRED EMBODIMENTS

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft or rotating part. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

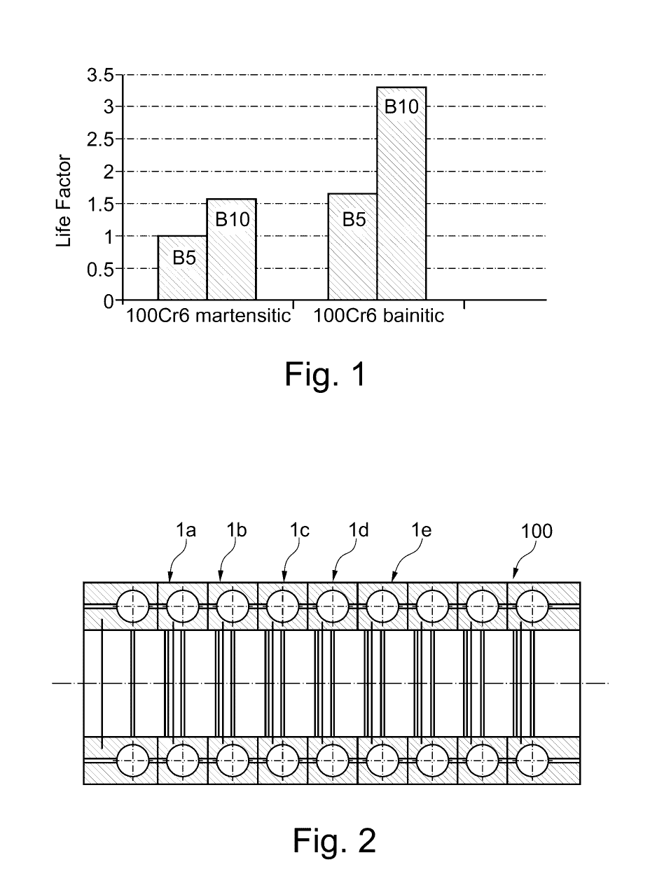

FIG. 1 is a bar graph showing the life factor of a 100Cr6 martensitic steel bearing component compared to a 100Cr6 bainitic steel bearing component. As shown in FIG. 1, B5 refers to a testing condition when 5% of a testing specimen statistically fails and B10 refers to when 10% of a testing specimen statistically fails. The B5 value of 100 Cr6 bainitic steel bearing ring has a life factor of 1.6, which is approximately a 60% increase over the life factor of 1.0 for the 100 Cr6 martensitic steel. The B10 value of 100 Cr6 bainitic steel bearing ring has a life factor of 3.4, which is more than a 125% increase over the life factor of 1.5 for 100 Cr6 martensitic steel. Improving the life cycle of bearing components for a stack bearing assembly, particularly for a drilling rig application, is desirable due to the significant time required to replace bearing rings in a stack bearing assembly and the high cost of downtime on a drilling rig.

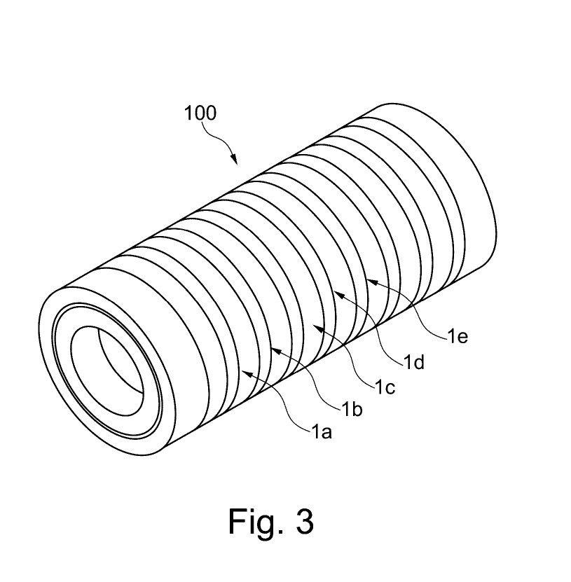

FIGS. 2 and 3 illustrate a known stack bearing assembly 100 including a plurality of rolling bearing assemblies 1a-1e. Each of the plurality of rolling bearing assemblies la-le include an inner bearing ring, an out bearing ring, and rolling elements located therebetween. According to the invention, the rolling bearing assemblies la-le each include at least one bearing ring comprised of 100 Cr6 bainitic steel. In one embodiment, the radially inner bearing rings of the rolling bearing assemblies la-le are formed of 100 Cr6 bainitic steel. In another embodiment, the radially outer bearing rings of the rolling bearing assemblies la-le are formed of 100 Cr6 bainitic steel. In another embodiment, both the radially inner bearing ring and the radially outer bearing ring are comprised of 100 Cr6 bainitic steel. The bainitic steel composition provides improved resistance to fracture and cracking compared to the known prior art bearing rings. Bainitic steel bearing rings also provides a six-fold improvement in impact resistance over martensitic steel bearing rings.

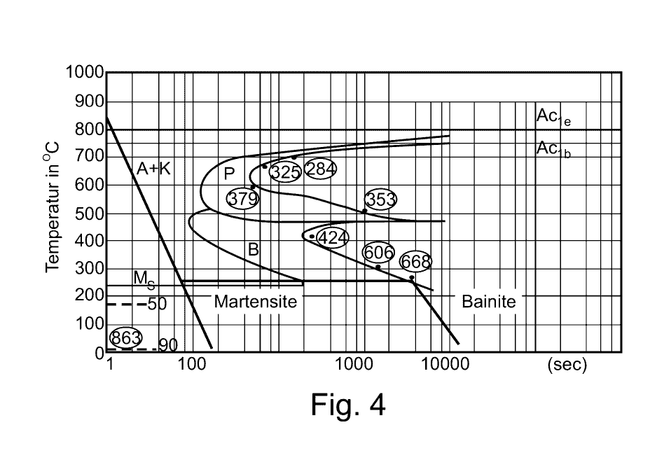

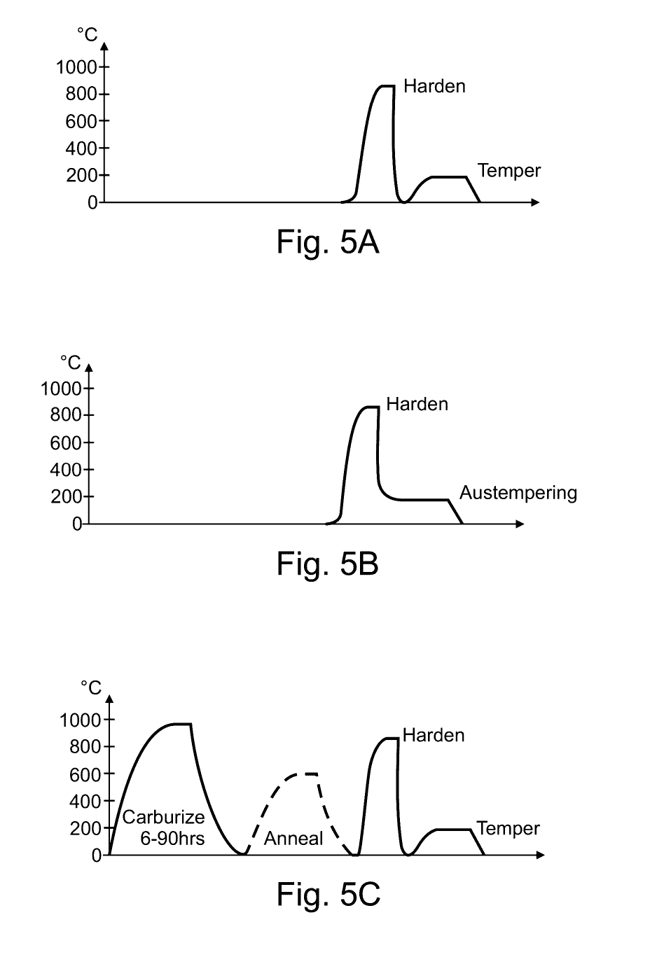

FIG. 4 illustrates heat treatment temperature profiles for bainitic bearing steel and martensitic bearing steel. FIGS. 5A-5C schematically show heat treatment graphs for through hardened martensitic bearing steel, through hardened bainitic bearing steel, and case carburized bearing steel, respectively. All of the heat treatment curves are shown for 58 HRC bearing steel. One of ordinary skill in the art recognizes that other types of steel can be used. In FIGS. 5A-5C, the Y-axis corresponds to temperature in Celsius, and the X-axis corresponds to time duration.

As shown in FIG. 5A, the through hardened martensitic bearing steel is heated to a very high temperature (e.g. 800° C.) and hardened, then cooled significantly (to room temperature, e.g. 20° C.) during a tempering phase. The martensitic hardening process consists of heating bearing steel to above an austenization temperature and holding the bearing steel at this temperature for a specified period. Once the core of the bearing steel has reached a predetermined temperature, the bearing steel is quenched in oil to below the martensitic start temperature to quickly lower its temperature. Once the bearing steel reaches the martensitic start temperature, the martensitic structure in the material begins to form. Once the bearing steel is cooled to room temperature, then the bearing steel is fully martensitic and through hardened. In stack bearing assemblies, the hard debris particles cause catastrophic failure due to the hardness and brittle microstructure characteristics of martensitic bearing steel.

As shown in FIG. 5B, bearing steel is heated to a very high temperature (e.g. 800° C.), then cooled to approximately 200° C. during an austempering phase to form through hardened bainitic bearing steel. The heat treatment schematic representations in FIGS. 5A and 5B are similar, but “cooling” phase for forming through hardened bainitic bearing steel requires a higher cooling temperature than the cooling temperature for forming through hardened martensitic bearing steel. Bainitic hardening uses the same bearing steel material as martensitic hardening, and the same austenitic furnace temperature. Once the core of the bearing steel reaches a predetermined temperature, the material is then cooled. The cooling process differs from martensitic hardening because the cooling process stops before the martensitic start temperature is reached. As the bearing steel is held above the martensitic start temperature for a predetermined period of time, the bainitic structure begins to form. The material can be held at this elevated predetermined temperature (i.e. above the martensitic start temperature), in a liquid salt bath, until the entire bearing steel has become fully bainitic and through hardened. After this formation step, the bearing steel is then be cooled to room temperature, resulting in a formed bainitic bearing steel component.

FIG. 5C illustrates a heat treatment characteristic graph for forming case carburized bearing steel. Case carburization provides a hard martensitic outer layer with a relatively soft and ductile core. This configuration helps prevent cracking due to stress in the soft core of the formed element, and prevents propagation throughout the entire formed element. As a result, a case carburized bearing steel element will experience chipping, eventually resulting in chunks breaking off of the formed element, however the entire formed element will not fracture, resulting in catastrophic failure of the associated bearing assembly. Case carburization is a diffusion process in a furnace and uses lower carbon steel than the through hardening formation described above. This diffusion process requires the formed parts to be in the furnace much longer than a through hardened process, and the formation process is much more complicated than a through hardening process.

Accordingly, by forming a bearing element in stack bearing from through hardened bainitic bearing steel, the stack bearing assembly has increased toughness characteristics than martensitic bearing steel and case hardened bearing steel, and has also exhibits improved wear characteristics than martensitic bearing steel and case hardened bearing steel. The through hardened bainitic bearing steel is also much easier to manufacture than case carburized bearing steel.

Having thus described the present invention in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

What is claimed is:

1. A bearing ring comprised of 100 Cr6 bainitic steel.

2. The bearing ring of claim 1, wherein the bearing ring is a radially inner bearing ring.

3. The bearing ring of claim 1, wherein the bearing ring is a radially outer bearing ring.

4. A stack bearing ring assembly comprising:
a plurality of rolling bearing assemblies stacked adjacent to each other, each of the plurality of rolling bearing assemblies including at least one bearing ring comprised of 100 Cr6 bainitic steel.

5. The stack bearing ring assembly of claim 4, wherein a radially inner bearing ring and a radially outer bearing ring of each of the plurality of rolling bearing assemblies is comprised of 100 Cr6 bainitic steel.
